(19) United States
(12) Patent Application Publication
(10) Pub. No.: US 2005/0155286 A1
(43) Pub. Date: Jul. 21, 2005

(54) Machine for cloning plant cuttings automatically using water culture

(76) Inventor: Kurt Michael Soukup, Las Vegas, NV (US)

Correspondence Address: Kurt Soukup, 5365 Rod Ct. 202, Las Vegas, NV, 89122, US

(21) Appl. No.: 10/759,812

(22) Filed: Jan. 16, 2004

(51) Int. Cl. A01G 31/02

(52) U.S. Cl. 47/60; 47/62 R

(57) ABSTRACT

A machine for cloning plant cuttings automatically using water culture with a reservoir and built in storage area with two supports to hold back of reservoir cover and structure for power cord to exit storage area, a reservoir tray with two drains, an inlet tube, and structure for water pump cord to exit reservoir nutrient holding area, a reservoir tray cover with a plurality of holes for foam cutting supports and two supports to hold front of reservoir cover, a reservoir cover with with slots for ventilation, a light support made from clear acrylic with slots for ventilation that fits inside reservoir cover, net baskets and foam inserts to support plant cuttings, a water pump and fluorescent light fixture(s).

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is an exploded view of the invention.

FIG. 3 is a schematic of the reservoir and storage area.

FIG. 4 is an exploded view of the tray and tray cover.

FIG. 5 is a schematic of the cover and light support (with lights installed).

### DETAILED DESCRIPTION OF THE PREFERRED EMBODIMENTS

Detailed descriptions of the preferred embodiment are provided herein, It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

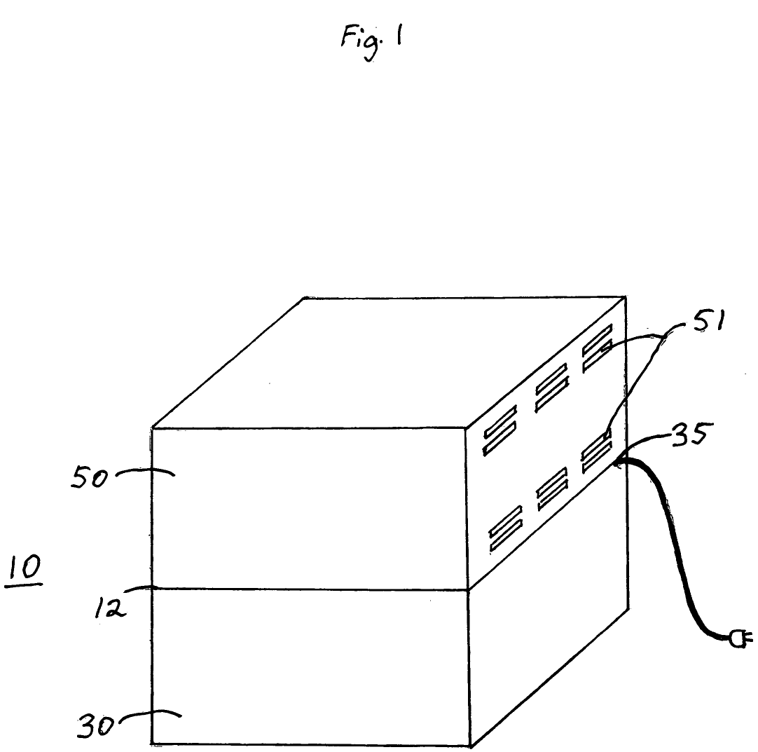

Turning now to FIG. 1 of the drawings, a perspective view of the preferred embodiment of the present invention is shown by reference numeral 10. The machine is constructed in the shape of a cube that is divided in the center horizontally 12. also shown in FIG. 1 are the ventilation slots 51 that are positioned on the back panel of the reservoir cover 50. In the preferred embodiment the machine would be made of 0.25 inch thick black acrylic sheet or similar material except for the light support 53 winch will be made of clear acrylic or similar material.

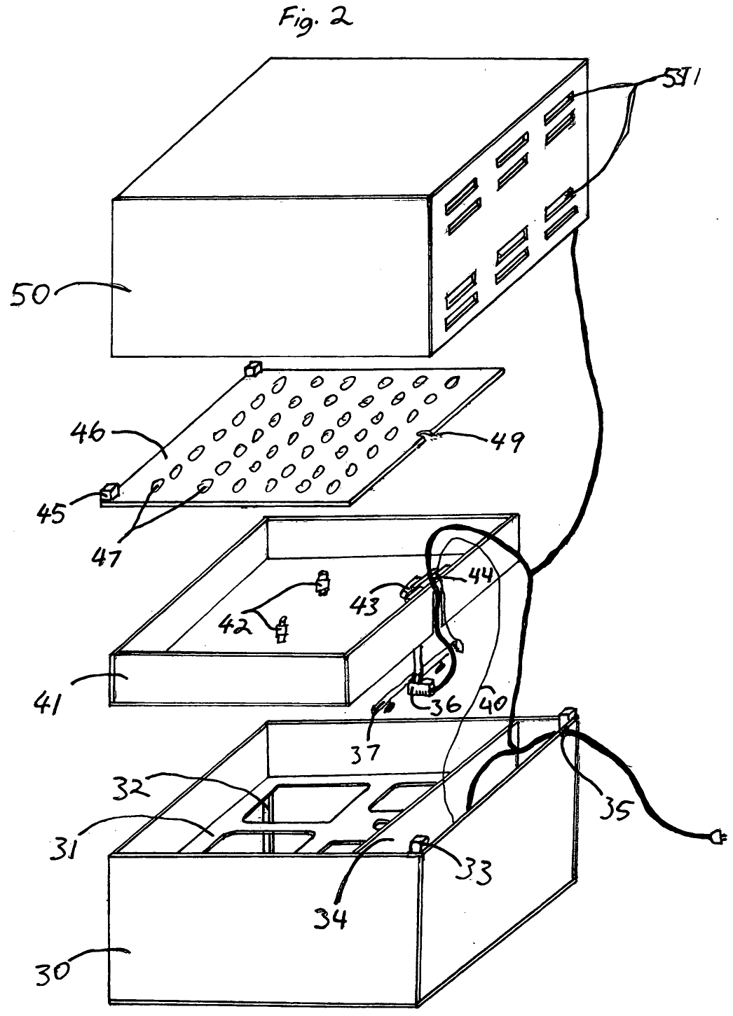

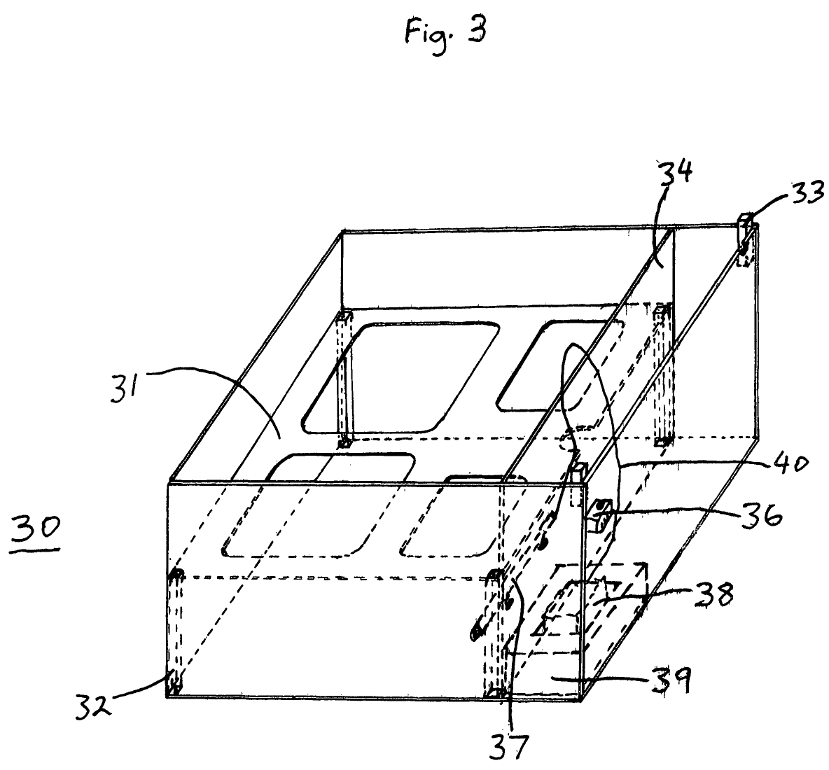

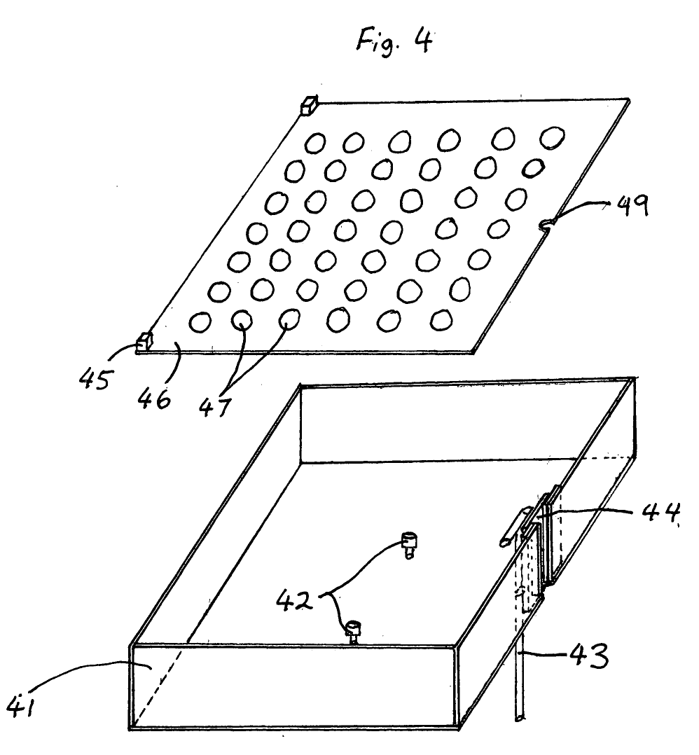

The operation of the present invention may be understood upon reference to FIGS. 2, 3, 4 and 5. When the machine is assembled (as in FIG. 1) the water pump 36 pumps nutrient solution from the reservoir 30 to the tray 41 and is returned to reservoir 30 through the drain fittings 42 which are positioned to maintain a nutrient level that is about half the depth of the tray 41. there is also an aerator 37 (located in the reservoir 30 near the water pump 36) that provides oxygen to the nutrient solution via an air pump 38 and air line 40. the air pump 38 is supported by a foam vibration dampener 39 and located in reservoir storage area. The air line 40 is attached to the air pump 38 and extends through a notch in the tray cover 49 and the structure provided in the tray 41 for power cord and air line 44. The end of the air line 40 is connected to the aerator 37. The tray 41 is supported by the tray support 31 and tray support legs 32 at such a level that the tray cover 46 is flush with the top of the reservoir and storage area when assembled, thereby positioning the front cover supports 45 to prevent cover 50 from sliding when assembled as in FIG. 1. the back cover supports 33 are mounted permanently to the reservoir 30 in the storage area. Also in the storage area is a notch 35 for power cord to exit machine.

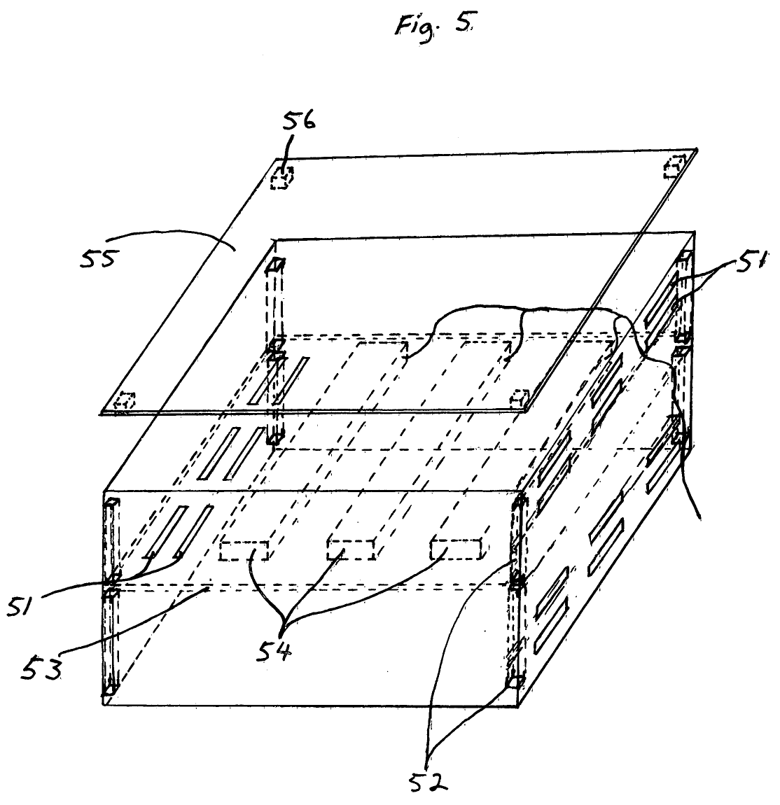

Having observed the details of the reservoir and storage area 30, the tray 41 and tray cover 46 attention may now be given to the cover 50 (FIG. 5) The light support 53 is positioned in the center of the cover 50 horizontally and is attached to the cover and structural supports 52. The cover 50 and light support 53 have a plurality of ventilation slots 51 that provide fresh air to plant cuttings (not shown) supported by foam plant cutting supports (not shown) located in the tray cover 46(FIG. 2) via convection caused by heat emitted from fluorescent light fixtures 54.

One of the features of the invention in the preferred embodiment to have a removable inspection lid 55 where said lid has inspection lid supports 56 to prevent lid from sliding when positioned as in FIG. 1. alternatively said lid could be permanently mounted to cover 50 and light support 53 would be removable.

An additional feature of the invention is the fact that when the machine is filled with nutrient solution and plant cuttings are inserted cover 50 is placed on top of reservoir 30 and power is applied, after setting up the machine initially, no human intervention is necessary during the cloning cycle thereby making the machine automatic, an additional feature of the invention is the fact that the machine includes lighting and ventilation, thereby making the machine self contained.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A machine for cloning plant cuttings automatically using water culture comprising: a reservoir and storage area with supports to hold back of reservoir cover and means for power cord to exit unit; a reservoir tray with two drains, an inlet tube, and means for water pump cord and air line to exit reservoir nutrient holding area; a reservoir tray cover with a plurality of openings for foam cutting supports, supports to hold front of reservoir cover, and a notch for power cord and air line to exit reservoir; a reservoir cover with slots for ventilation and structure for mounting light support; a light support made from clear acrylic that fits inside reservoir cover with slots for ventilation.

2. A machine for cloning plant clippings automatically using water culture as claimed in claim 1 wherein said reservoir and storage area, reservoir tray, reservoir tray cover, and light support are constructed of 0.25 inch acrylic sheet or similar material;

3. A machine for cloning plant clippings automatically using water culture as claimed in claim 1 wherein said machine has dimensions of no more than 20″H×20″D×20″W

4. A machine for cloning plant cuttings automatically using water culture as claimed in claim 1 wherein said machine uses no more than 8 gallons of nutrient solution
